(19) United States
(12) Patent Application Publication
(10) Pub. No.: US 2016/0224808 A1
(43) Pub. Date: Aug. 4, 2016

(54) INFORMATION INPUT METHOD HAVING CONFIDENTIALITY

(71) Applicant: Lanner Electronic Inc., New Taipei City (TW)

(72) Inventor: YUAN-SHUN YEH, New Taipei City (TW)

(21) Appl. No.: 15/011,757

(22) Filed: Feb. 1, 2016

(30) Foreign Application Priority Data
Feb. 4, 2015 (TW) 104103732

(51) Int. Cl. G06F 21/83; G06F 3/0488; G06F 1/16; G06T 19/00

(52) U.S. Cl. CPC G06F 21/83; G06T 19/006; G06F 3/04883; G06F 3/04886; G06F 1/163

(57) ABSTRACT

The present invention provides an information input method having confidentiality. Differing from the conventional password inputting keyboard is commonly a visible entity keyboard or a visible virtual keyboard, a user can utilizes a display boundary of a wearable display to define an operation region on a touch pad of an electronic device through the information input method of the present invention. Then, the wearable display would show a virtual keyboard corresponding to the operation region to the user, and the virtual keyboard showed by the wearable display is only seen by the user. Therefore, even if the user input a set of passwords by performing finger movements on the touch pad, the other person cannot guess the correct password set from the finger movements. Besides, the password set also cannot be recorded after using a surveillance software to monitor the button struck on the touch pad.

### BACKGROUND OF THE INVENTION

1. Field of the Invention

The present invention relates to the technology field of input methods, and more particularly to an information input method having confidentiality.

2. Description of the Prior Art

Commonly, personal information such as computer login password and bank account password are protected by way of security encryption mechanisms. After input the authentication password, the computer or the bank account can be used and accessed.

However, the conventional input and display procedures of the authentication password have become security loopholes under some circumstances. For example, users need to key in an ATM card password after inserting an ATM card into the card slot of an ATM. Please refer to FIG. 1, which illustrates a top view of a numeric keypad of the ATM. As FIG. 1 shows, the numeric keypad 1′ has ten number buttons, one “OK” button and one “Cancel” button. It can find that, because the positions of the ten number buttons are fixed, a third person may guess the ATM card password from the finger movements of the ATM users.

Moreover, since the computer keyboard has become the commonly-used input device, a surveillance software called “keylogger recorder” is developed to monitor the button struck on the keyboard. The keylogger recorder can record instant messages, e-mail, and any information that users type at any time using their keyboard.

Thus, because the conventional password or personal information input ways obviously lack effective security, the inventor of the present application has made great efforts to make inventive research thereon and eventually provided an information input method having confidentiality.

### SUMMARY OF THE INVENTION

The primary objective of the present invention is to provide an information input method having confidentiality. Differing from the conventional password inputting keyboard is commonly a visible entity keyboard or a visible virtual keyboard showing on the display, a user can utilizes a display boundary of a wearable display to define an operation region on a touch pad of an electronic device through the information input method of the present invention. Then, the wearable display would show a virtual keyboard corresponding to the operation region to the user, and the virtual keyboard showed by the wearable display is only seen by the user. Therefore, even if the user input a set of passwords by performing finger movements on the touch pad, the other person cannot guess the correct password set from the finger movements.

Besides, the password set also cannot be recorded after using a surveillance software such as keylogger recorder to monitor the button struck on the touch pad.

Accordingly, in order to achieve the primary objective of the present invention, the inventor of the present invention provides an information input method having confidentiality, comprising steps of:
(1) providing a wearable display and an electronic device with a touch module;
(2) making the touch module to locate in a display boundary of the wearable display;
(3) the wearable display defining an operation region in the display boundary;
(4) the wearable display communicating with the electronic device;
(5) the electronic device transmitting an encryption signal to the wearable display;
(6) the wearable display showing an operating pattern on the operation region; and
(7) inputting a specific information to the electronic device through the touch module.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a top view of a numeric keypad of an ATM;

FIG. 2 shows a flow chart of an information input method having confidentiality according to the present invention;

FIG. 3 shows a schematic first application diagram of the information input method having confidentiality;

FIG. 4A, FIG. 4B and FIG. 4C show different virtual keypad patterns;

FIG. 4D shows top view of a touch module;

FIG. 5 shows a schematic second application diagram of the information input method having confidentiality;

FIG. 6 shows a schematic third application diagram of the information input method having confidentiality.

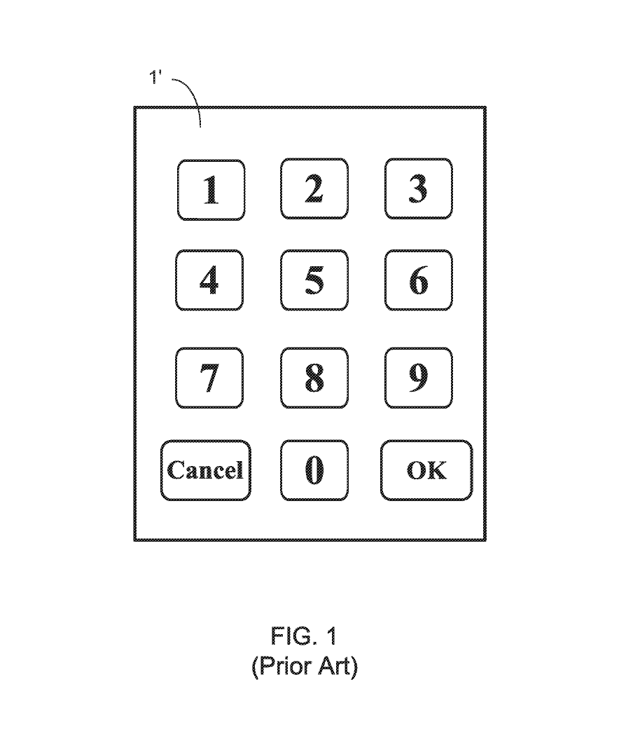

### DETAILED DESCRIPTION OF THE PREFERRED EMBODIMENTS

To more clearly describe an information input method having confidentiality according to the present invention, embodiments of the present invention will be described in detail with reference to the attached drawings hereinafter.

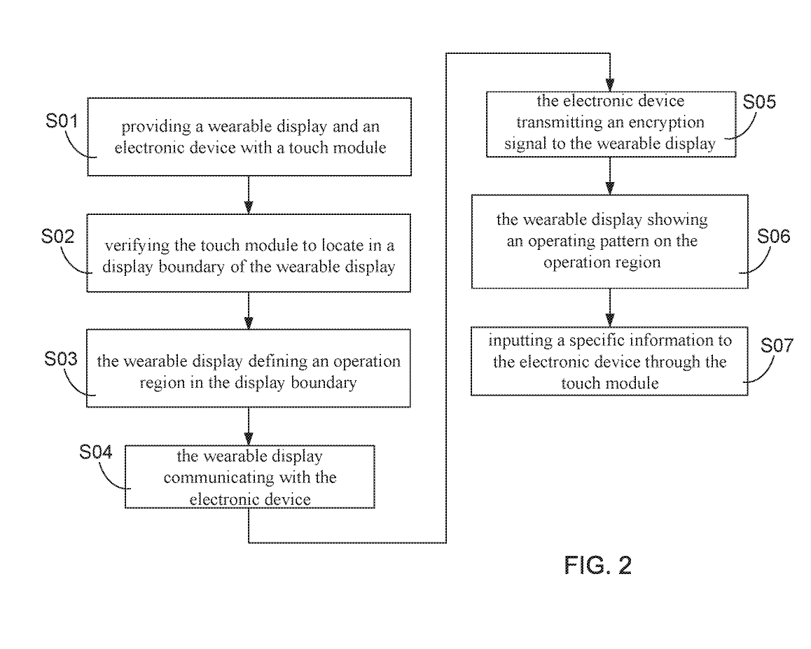

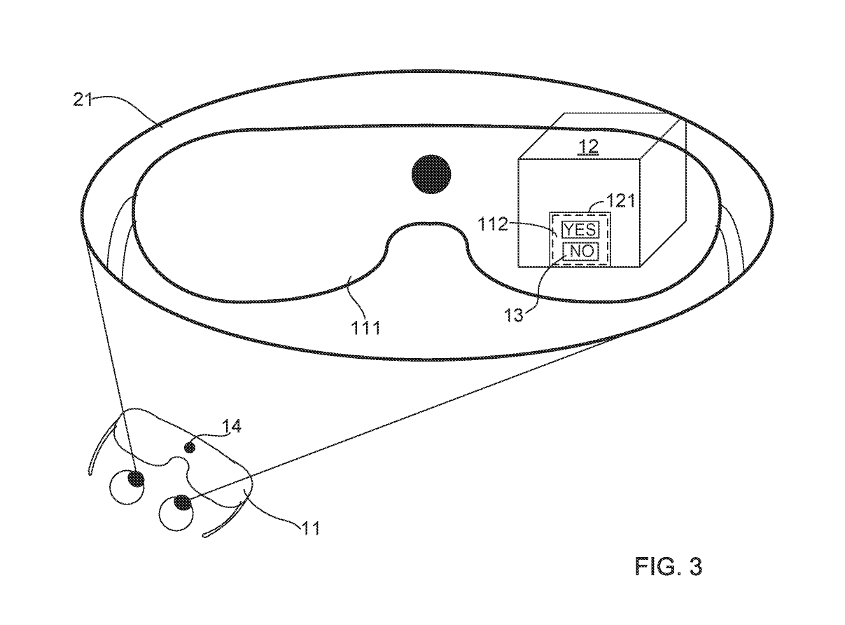

Please referring to FIG. 2, which illustrates a flow chart of an information input method having confidentiality according to the present invention. Moreover, please refer to FIG. 3, there is shown a schematic first application diagram of the information input method having confidentiality. As FIG. 2 and FIG. 3 show, the information input method of the present invention comprises 7 method steps.

Firstly, the method proceeds to steps (S01) and (S02) for providing a wearable display 11 and an electronic device 12 with a touch module 121, so as to make the touch module 121 to locate in a display boundary 111 of the wearable display 11. Next, the method proceeds to step (S03) for using the wearable display 11 to define an operation region 112 in the display boundary 111. Subsequently, the steps (S04) and (S05) are executed for making the wearable display 11 communicate with the electronic device 12, so as to transmit an encryption signal from the electronic device 12 to the wearable display 11. Therefore, according to the encryption signal, the wearable display 11 shows an operating pattern 13 on the operation region 112 (Step (S06)), such that a user wearing with the wearable display 11 is able to input a specific information such as a set of password to the electronic device 12 through the touch module 121.

In the present invention, the said wearable display 11 can be a mask, a glass, an eye protecting glass, or a helmet having a windshield. As FIG. 3 shows, the wearable display 11 is exemplarily a Google glass. Through the Google glass, the user can see the touch module 121 in the real word, or see a visual keypad displayed by the Google glass. In addition, because the Google glass has a sensing module 14 such as camera, the Google glass can also show a real-time video of the touch module 121, the electronic device 12, or any other things captured by the sensing module 14. Briefly, the user can see a real word through the Google glass, or a real-time video of the real world. The most important is that, the sensing module 14 is primary used for verifying whether the touch module 121 locates in the display boundary 11 of the wearable display 11 or not.

The wearable display 11 has a controlling and processing module, which can be a central processor directly integrated in the wearable display 11, one wearable device such as a smart watch, or one portable device such as smart phone. By the controlling and processing module, the wearable display 11 is able to communicate with the electronic device 12 by wired or wireless way. The aforesaid wireless way can be Wi-Fi, Bluetooth, infrared ray, RFID, ZigBee, 3G, and 4G.

With reference to FIG. 3, when the user sees a real word 21 through the Google glass (i.e., the wearable display 11), the glass boundary would be defied as the said display boundary 111 of the wearable display 11. Thus, after making the touch module 121 locate in the display boundary 111 through the sensing module 14 or human eyes, the controlling and processing module of the wearable display 11 would calculate and produce an operation region 112 according to the touch module 121. Therefore, after an encryption signal is transmitted from the electronic device 12 to the wearable display 11, the controlling and processing module would produce an operation pattern 13. Herein, it needs to particularly explain that, the said operation pattern 13 is a virtual keypad pattern having a plurality of inputting buttons randomly arranged and defined, and the virtual keypad pattern is shown on the glasses of the Google glass (i.e., the wearable display), such that the virtual keypad pattern is only seen by the user.

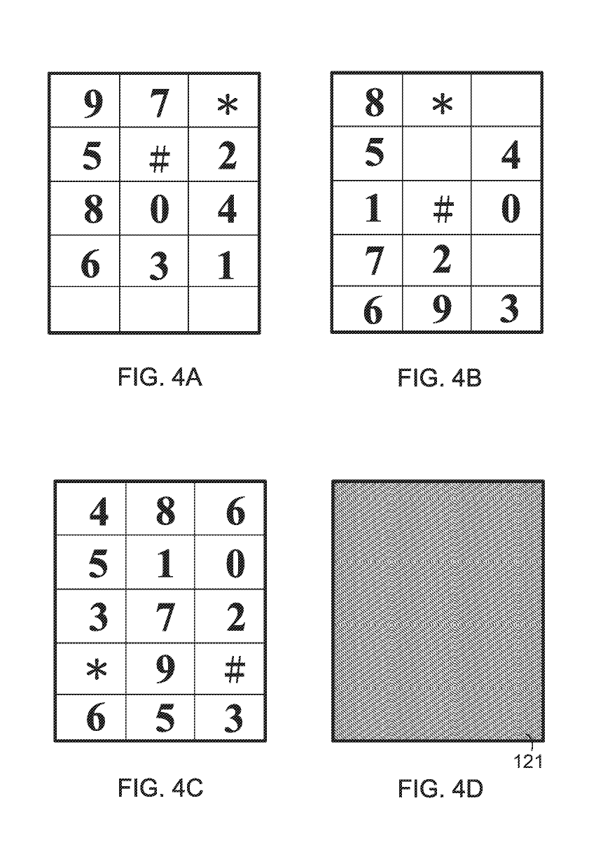

Referring to FIG. 3 again, and please simultaneously refer to FIG. 4A, FIG. 4B, and FIG. 4C, which illustrate different virtual keypad patterns. As shown by FIG. 4A, FIG. 4B and FIG. 4C, the virtual keypad pattern is formed as a button array by the constitution of randomly arranged and defined inputting buttons. In the present invention, the inputting buttons comprises numeric buttons, alphabet buttons, Chinese phonetic alphabet buttons, symbol buttons, and basic operation buttons including OK button, Cancel button, Return button, correction button, and arrow buttons. Moreover, each of the inputting buttons have a corresponding coordinate position on the touch module 121 of the electronic device 12, and all of the coordinate positions being stored in the electronic device 12.

As FIG. 4A shows, a first virtual button array consists of ten numeric buttons (0-9), two symbol buttons (# ,*), and three NA (Not Available) buttons. Moreover, as FIG. 4B shows, a second virtual button array consists of ten numeric buttons (0-9), two symbol buttons (# ,*), and three NA (Not Available) buttons. However, the positions of the numeric buttons, the symbol buttons and the NA buttons of the second virtual button array are all different from the positions of the numeric buttons, the symbol buttons and the NA buttons of the first virtual button array. Furthermore, as FIG. 4C shows, a third virtual button array consists of thirteen numeric buttons (0-9) and two symbol buttons (# ,*), wherein the thirteen numeric buttons particularly include at least two identical inputting buttons, i.e., two numeric “3” buttons, two numeric “5” buttons and two numeric “6” buttons.

In addition, when the user utilize the wearable display 11 and the touch module 121 to input a password set into the electronic device 12, the user is able to perform a switching gesture on the touch module 121; meanwhile, the electronic device 12 would transmit another one encryption signal to the wearable display, and then the wearable display 11 would display a second keypad pattern to the user.

Please refer to FIG. 4D, which illustrate the top view of the touch module. As FIG. 4D shows, when the user utilize the wearable display 11 and the touch module 121 to input a password set into the electronic device 12, a third person cannot guess the correct password set from the finger movements of the user because the third person can just see the top view of the touch module 121 without displaying any keypad patterns. Therefore, even if the user input a set of passwords by performing finger movements on the touch module 121, the other person cannot guess the correct password set from the finger movements. Besides, the password set also cannot be recorded after using the surveillance software of keylogger recorder to monitor the button struck on the touch module 121.

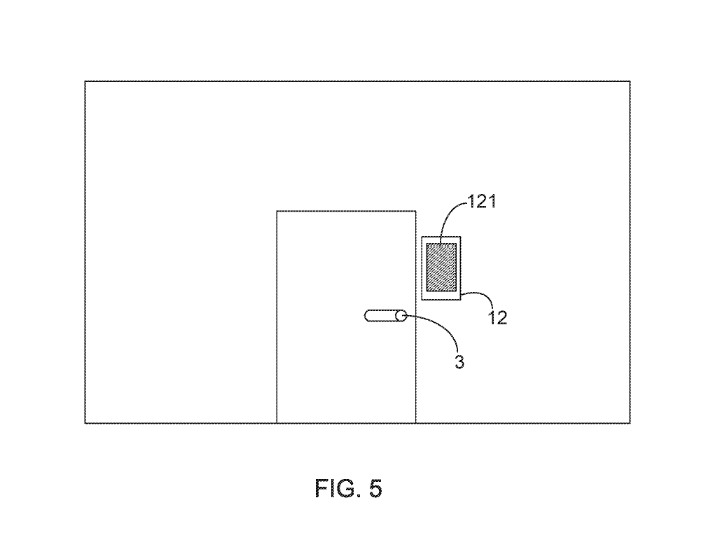

Please refer to FIG. 5, there is shown a schematic second application diagram of the information input method having confidentiality. As FIG. 5 shows, the said electronic device 12 is exemplarily a door station having a touch panel. Thus, after making the touch module 121 (i.e., the touch panel of the door station) locate in the display boundary 111 of the wearable display 11, the wearable display 11 would produce an operation region according to the touch module 121. Therefore, after an encryption signal is transmitted from the door station to the wearable display 11, the wearable display 11 would show a virtual keypad pattern to the user. Therefore, after the user key in a set of passwords into the door station through the virtual keypad pattern, the door station would open the door lock 3, such that the user can open the door and then get into the housing.

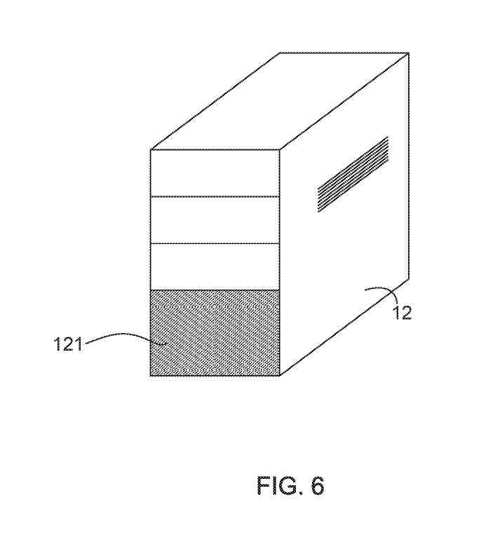

Please refer to FIG. 5, there is shown a schematic third application diagram of the information input method having confidentiality. As FIG. 6 shows, the said electronic device 12 is exemplarily a computer host having a touch panel. Thus, after making the touch module 121 (i.e., the touch panel of the computer host) locate in the display boundary 111 of the wearable display 11, the wearable display 11 would produce an operation region according to the touch module 121. Therefore, after an encryption signal is transmitted from the computer host to the wearable display 11, the wearable display 11 would show a virtual keypad pattern to the user. Therefore, after the user key in a set of passwords into the computer host through the virtual keypad pattern, the computer host can be accessed by the user.

Therefore, through above descriptions, the information input method having confidentiality provided by the present invention has been introduced completely and clearly; in summary, the present invention includes the advantages of:

(1) Differing from the conventional password inputting keyboard is commonly a visible entity keyboard or a visible virtual keyboard, a user can utilizes a display boundary of a wearable display to define an operation region on a touch pad of an electronic device through the information input method of the present invention. Then, the wearable display would show a virtual keyboard corresponding to the operation region to the user, and the virtual keyboard showed by the wearable display is only seen by the user. Therefore, even if the user input a set of passwords by performing finger movements on the touch pad, the other person cannot guess the correct password set from the finger movements. Besides, the password set also cannot be recorded after using a surveillance software such as keylogger recorder to monitor the button struck on the touch pad.

The above description is made on embodiments of the present invention. However, the embodiments are not intended to limit scope of the present invention, and all equivalent implementations or alterations within the spirit of the present invention still fall within the scope of the present invention.

What is claimed is:

1. An information input method having confidentiality, comprising step of:
(1) providing a wearable display and an electronic device with a touch module;
(2) making the touch module to locate in a display boundary of the wearable display;
(3) the wearable display defining an operation region in the display boundary;
(4) the wearable display communicating with the electronic device;
(5) the electronic device transmitting a first encryption signal to the wearable display;
(6) the wearable display showing an operating pattern on the operation region; and
(7) inputting a specific information to the electronic device through the touch module.

2. The information input method of claim 1, wherein the wearable display communicates with the electronic device by wired communication or wireless communication.

3. The information input method of claim 1, wherein the wearable display verifies the touch module to locate in the display boundary by using a sensing module.

4. The information input method of claim 1, wherein the operation pattern is a first keypad pattern having a plurality of inputting buttons randomly arranged and defined, and the randomly arranged and defined inputting buttons being produced by the electronic device.

5. The information input method of claim 2, wherein the aforesaid wireless communication is selected from the group consisting of: Wi-Fi communication, Bluetooth communication, infrared ray communication, RFID communication, ZigBee communication, 3G communication, and 4G communication.

6. The information input method of claim 3, wherein the sensing module is a camera.

7. The information input method of claim 4, wherein the randomly arranged and defined inputting buttons constitute a button array.

8. The information input method of claim 7, wherein each of the inputting buttons have a corresponding coordinate position on the touch module of the electronic device, and all of the coordinate positions being stored in the electronic device.

9. The information input method of claim 8, wherein the inputting buttons comprises: numeric buttons, alphabet buttons, Chinese phonetic alphabet buttons, symbol buttons, and basic operation buttons.

10. The information input method of claim 9, wherein the aforesaid basic operation buttons comprises: OK button, Cancel button, Return button, correction button, and arrow buttons.

11. The information input method of claim 9, wherein the inputting buttons further comprises at least one NA (Not Available) button.

12. The information input method of claim 9, wherein the button array has at least two identical inputting buttons.

13. The information input method of claim 9, wherein after a switching gesture is finished on the touch module, the electronic device would transmit a second encryption signal to the wearable display, and then the wearable display would display a second keypad pattern.
